(19) United States
(12) Patent Application Publication
(10) Pub. No.: US 2011/0268180 A1
(43) Pub. Date: Nov. 3, 2011

(54) Method and System for Low Complexity Adaptive Quantization

(76) Inventors: Naveen Srinivasamurthy, Bangalore (IN); Tomoyuki Naito, Richardson, TX (US)

(21) Appl. No.: 12/770,677

(22) Filed: Apr. 29, 2010

(51) Int. Cl. H04N 7/26

(52) U.S. Cl. 375/240.03; 375/240.24; 375/E07.126

(57) ABSTRACT

A method of encoding a block of pixels in a digital video sequence that includes computing an average texture measure for a plurality of blocks of pixels encoded prior to the block of pixels, computing a texture measure for the block of pixels, computing a block quantization step size for the block of pixels as the product of a quantization step size selected for a sequence of blocks of pixels comprising the block of pixels and a multiplication factor selected from a set of multiplication factors based on a ratio of the texture measure and the average texture measure, and quantizing the block of pixels using the block quantization step size.

### BACKGROUND OF THE INVENTION

The demand for digital video products continues to increase. Some examples of applications for digital video include video communication, security and surveillance, industrial automation, and entertainment (e.g., DV, HDTV, satellite TV, set-top boxes, Internet video streaming, digital cameras, cellular telephones, video jukeboxes, high-end displays and personal video recorders). Further, video applications are becoming increasingly mobile as a result of higher computation power in handsets, advances in battery technology, and high-speed wireless connectivity.

Video compression is an essential enabler for digital video products. Compression-decompression (CODEC) algorithms enable storage and transmission of digital video. In general, the encoding process of video compression generates coded representations of frames or subsets of frames. The encoded video bitstream, i.e., encoded video sequence, may include three types of frames: intracoded frames (I-frames), predictive coded frames (P-frames), and bi-directionally coded frames (B-frames). I-frames are coded without reference to other frames. P-frames are coded using motion compensated prediction from I-frames or P-frames. B-frames are coded using motion compensated prediction from both past and future reference frames. For encoding, all frames are divided into macroblocks, e.g., 16×16 pixels in the luminance space and 8×8 pixels in the chrominance space for the simplest sub-sampling format.

Video coding standards (e.g., MPEG, H.264, etc.) are based on the hybrid video coding technique of block motion compensation and transform coding. Block motion compensation is used to remove temporal redundancy between blocks of a frame and transform coding is used to remove spatial redundancy in the video sequence. Traditional block motion compensation schemes basically assume that objects in a scene undergo a displacement in the x- and y-directions from one frame to the next. Motion vectors are signaled from the encoder to a decoder to describe this motion. As part of forming the coded signal, a block transform is performed and the resulting transform coefficients are quantized to reduce the size of the signal to be transmitted and/or stored.

In some video coding standards, a quantization parameter (QP) is used to modulate the step size of the quantization for each block. For example, in H.264/AVC, quantization of a transform coefficient involves dividing the coefficient by a quantization step size. The quantization step size, which may also be referred to as the quantization scale, is define by the standard based on the QP value, which may be an integer from 0 to 51. A step size for a QP value may be determined, for example, using a table lookup and/or by computational derivation. The quality and bit rate of the coded bitstream is determined by the QP value selected by the encoder for quantizing each block. The use of coarser quantization encodes a frame using fewer bits but reduces image quality while the use of finer quantization encodes a frame using more bits but increases image quality. Further, in some standards, the QP values may be modified within a frame. For example, in various versions of the MPEG standard and in H.263 and H.264, a different QP can be defined for each 16×16 block in a frame.

In general, two approaches have been used to select QP values, uniform quantization and adaptive quantization. In uniform quantization, the same or close to the same QP value is used for all blocks in a frame. This approach uniformly distributes any quantization noise and coding artifacts caused by data compression throughout a frame. The adaptive quantization approach varies the QP value for blocks in a frame to distribute the noise and artifacts according to masking properties of the human visual system (HVS). The goal is to maximize the visual quality of an encoded video sequence while keeping the bit rate low. For example, according to HVS theory, the human visual system performs texture masking (also called detail dependence, spatial masking or activity masking). That is, the discrimination threshold of the human eye increases with increasing picture detail, making the human eye less sensitive to quantization noise and coding artifacts in busy or highly textured portions of frames and more sensitive in flat or low-textured portions. During video encoding, this texture masking property of the HVS can be exploited by shaping the quantization noise in the video frame based on the texture content in the different parts of the video frame. More specifically, the quantization step size can be increased in highly textured portions, resulting in coarser quantization and a lower bit rate requirement, and can be decreased in low-textured or flat portions to maintain or improve video quality, resulting in finer quantization but a higher bit rate requirement. The human eye will perceive a “noise-shaped” video frame as having better subjective quality than a video frame which has the same amount of noise evenly distributed throughout the video frame.

The challenge in doing the “noise shaping” is in efficiently determining the quantization step size value to be used for a block based on its texture content. This is especially challenging in low complexity embedded systems used in cell phones, video cameras, etc. For example, some previously proposed quantization step size derivation techniques involved divisions or look up tables, e.g., adaptive quantization in MPEG-2 test model 5 (TM5). The adaptive auantization used in TM5 is shown below.

$${Q}_{mb} = {Q}_{base} * \frac{2 * TM + {TM}_{avg}}{TM + 2 * {TM}_{avg}}$$

where TM is a texture measure computed for a macroblock, TM_{avg} is an average texture measure from previous macroblocks, and Q_{base} is the quantization step size selected by rate control for a frame, row, etc. Performing division operations while encoding every block may be prohibitive when encoding video sequences on embedded systems with limited resources, especially for HD video sequences.

Further, some known techniques for estimating texture content and deriving the quantization step size value perform a continuous mapping from the texture measure to the quantization step size (as observed in the adaptive quantization in TM5). Such an approach may result in adjacent blocks being assigned different quantization step sizes even when the blocks only differ marginally in the texture measure. The outcome is that very similar adjacent blocks may have different quantization distortion leading to rapid subjective quality variation in almost homogenous regions. Furthermore, in many video encoding standards, the difference in the QP value between adjacent blocks is typically transmitted. Entropy encoders in video encoders are very efficient in encoding the QP value difference when it is zero. However, when the QP value fluctuates between blocks, additional bits are expended in transmitting the difference, thus contributing to decreased rate-distortion (RD) performance.

### BRIEF DESCRIPTION OF THE DRAWINGS

Particular embodiments in accordance with the invention will now be described, by way of example only, and with reference to the accompanying drawings:

FIG. 1 shows a block diagram of a digital system in accordance with one or more embodiments of the invention;

FIGS. 2A and 2B show block diagrams of a video encoder in accordance with one or more embodiments of the invention;

FIG. 3 shows a flow diagram of a method in accordance with one or more embodiments of the invention;

FIG. 4 shows a graph in accordance with one or more embodiments of the invention; and

FIGS. 5-7 show illustrative digital systems in accordance with one or more embodiments of the invention.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

Certain terms are used throughout the following description and the claims to refer to particular system components. As one skilled in the art will appreciate, components in digital systems may be referred to by different names and/or may be combined in ways not shown herein without departing from the described functionality. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” and derivatives thereof are intended to mean an indirect, direct, optical, and/or wireless electrical connection. Thus, if a first device couples to a second device, that connection may be through a direct electrical connection, through an indirect electrical connection via other devices and connections, through an optical electrical connection, and/or through a wireless electrical connection.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. In addition, although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps shown in the figures and/or described herein. Further, embodiments of the invention should not be considered limited to any particular video coding standard. In addition, for convenience in describing embodiments of the invention, the term frame may be used to refer to the portion of a video sequence being encoded, i.e., a coding unit of the video sequence. One of ordinary skill in the art will understand embodiments of the invention that operate on coding units that are subsets of frames, such as, for example, a slice, a field, a video object plane, etc.

In general, embodiments of the invention provide for low complexity adaptive quantization during encoding of a video sequence that reduces fluctuation in quantization step size. More specifically, a texture measure is computed for each macroblock in a frame and the quantization step size for the macroblock is derived as a function of (i) the quantization step size selected by the video encoder rate control, (ii) the texture measure, and (iii) the average texture measure of the previous N frames. A discrete mapping between the texture measure and quantization step size is used that, in some embodiments, is implemented with fixed-point multiplication and comparisons for use in embedded systems, thus providing reduced complexity and memory requirements as compared to previous techniques that use division operations and/or look up tables. In addition, the same quantization step size is assigned to macroblocks having similar texture, thus potentially reducing QP value fluctuations between similar macroblocks.

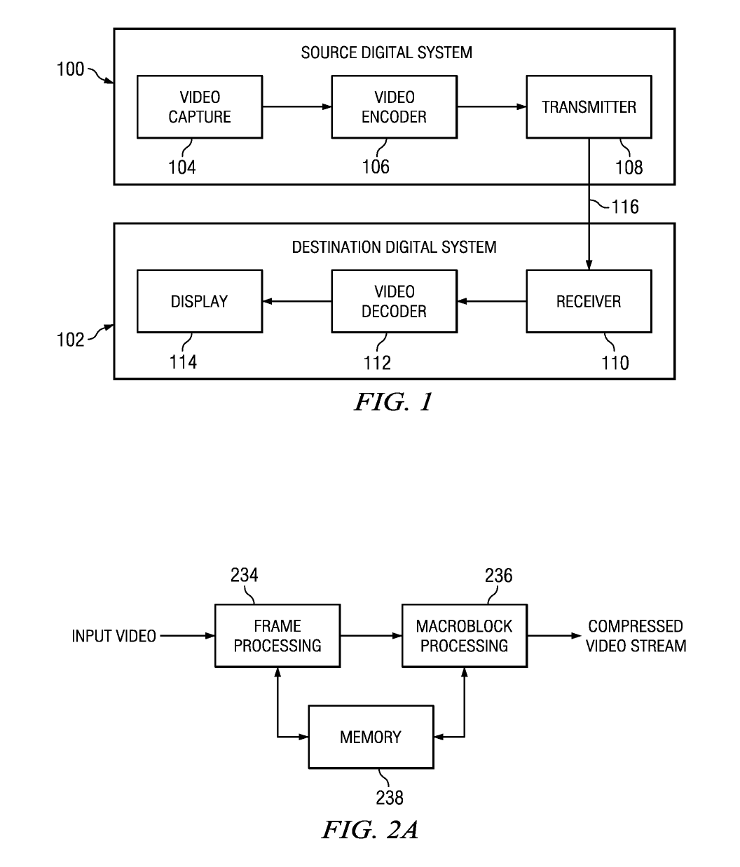

FIG. 1 shows a block diagram of a digital system in accordance with one or more embodiments of the invention. The digital system is configured to perform coding of digital video sequences using embodiments of the methods described herein. The system includes a source digital system (100) that transmits encoded video sequences to a destination digital system (102) via a communication channel (116). The source digital system (100) includes a video capture component (104), a video encoder component (106) and a transmitter component (108). The video capture component (104) is configured to provide a video sequence to be encoded by the video encoder component (106). The video capture component (104) may be for example, a video camera, a video archive, or a video feed from a video content provider. In some embodiments of the invention, the video capture component (104) may generate computer graphics as the video sequence, or a combination of live video and computer-generated video.

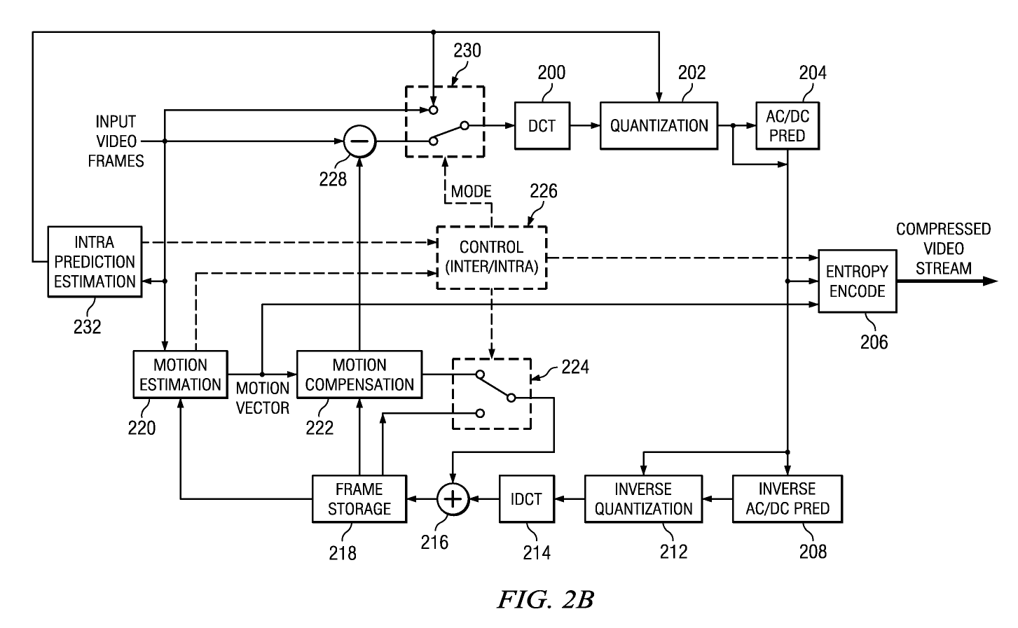

The video encoder component (106) receives a video sequence from the video capture component (104) and encodes it for transmission by the transmitter component (108). In general, the video encoder component (106) receives the video sequence from the video capture component (104) as a sequence of frames, divides the frames into coding units which may be a whole frame or a part of a frame, divides the coding units into blocks of pixels (e.g., macroblocks), and encodes the video data in the coding units based on these blocks. During the encoding process, a method for low complexity adaptive quantization in accordance with one or more of the embodiments described herein may be used. The functionality of embodiments of the video encoder component (106) is described in more detail below in reference to FIGS. 2A and 2B.

The transmitter component (108) transmits the encoded video data to the destination digital system (102) via the communication channel (116). The communication channel (116) may be any communication medium, or combination of communication media suitable for transmission of the encoded video sequence, such as, for example, wired or wireless communication media, a local area network, or a wide area network.

The destination digital system (102) includes a receiver component (110), a video decoder component (112) and a display component (114). The receiver component (110) receives the encoded video data from the source digital system (100) via the communication channel (116) and provides the encoded video data to the video decoder component (112) for decoding. In general, the video decoder component (112) reverses the encoding process performed by the video encoder component (106) to reconstruct the frames of the video sequence. The reconstructed video sequence may then be displayed on the display component (114). The display component (114) may be any suitable display device such as, for example, a plasma display, a liquid crystal display (LCD), a light emitting diode (LED) display, etc.

In some embodiments of the invention, the source digital system (100) may also include a receiver component and a video decoder component and/or the destination digital system (102) may include a transmitter component and a video encoder component for transmission of video sequences both directions for video steaming, video broadcasting, and video telephony. Further, the video encoder component (106) and the video decoder component (112) may perform encoding and decoding in accordance with one or more video compression standards such as, for example, the Moving Picture Experts Group (MPEG) video compression standards, e.g., MPEG-1, MPEG-2, and MPEG-4, the ITU-T video compression standards, e.g., H.263 and H.264, the Society of Motion Picture and Television Engineers (SMPTE) 421 M video CODEC standard (commonly referred to as “VC-1”), the video compression standard defined by the Audio Video Coding Standard Workgroup of China (commonly referred to as “AVS”), etc. The video encoder component (106) and the video decoder component (112) may be implemented in any suitable combination of software, firmware, and hardware, such as, for example, one or more digital signal processors (DSPs), microprocessors, discrete logic, application specific integrated circuits (ASICs), field-programmable gate arrays (FPGAs), etc.

FIGS. 2A and 2B show block diagrams of a video encoder, e.g., the video encoder (106) of FIG. 1, configured to perform low complexity adaptive quantization in accordance with one or more embodiments of the invention. More specifically, FIG. 2A shows a high level block diagram of the video encoder and FIG. 2B shows the basic macroblock coding architecture of the video encoder. The macroblock coding architecture shown is that of an MPEG-4 video encoder for illustrative purposes.

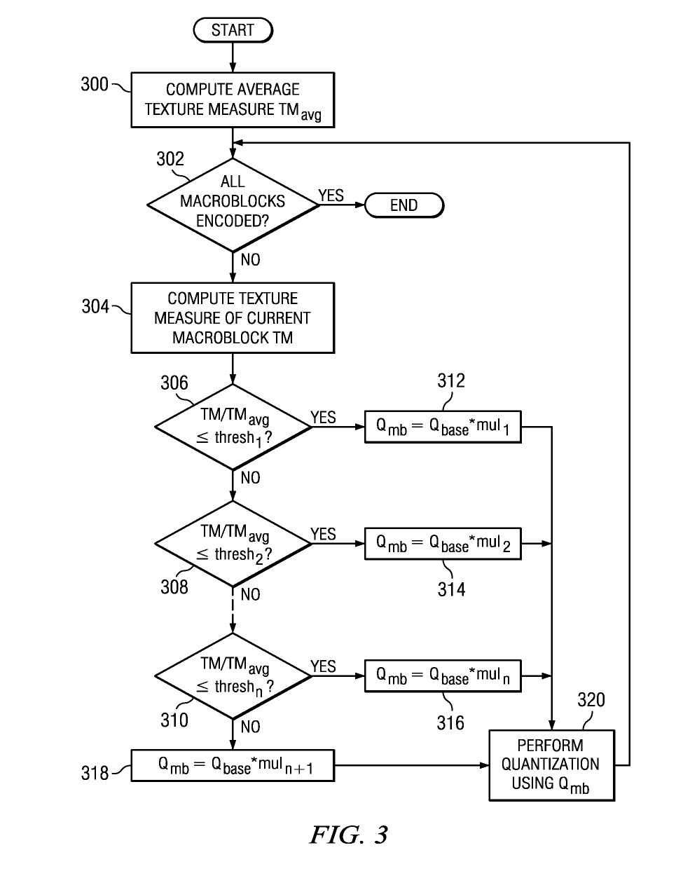

As shown in FIG. 2A, a video encoder includes a frame processing component (234), a macroblock block processing component (236) and a memory (238). An input digital video sequence is provided to the frame processing component (234). The memory (238) may be internal memory, external memory, or a combination thereof. The frame processing component (234) performs any processing on the input video sequence that is to be done at the frame level and then provides the video frames to the macroblock processing component (236) for encoding. The frame processing component (234) included rate control functionality to compute a quantization step size for each frame, i.e., a base quantization step size, and functionality to compute an average texture measure for each frame. The base quantization step size and the average texture measure are stored in memory (238) for use by the macroblock processing component (236). The average texture measure is computed from the macroblock texture measures of the previous N frames in the video sequence. In some embodiments of the invention, N=1. As is explained in more detail below in reference to FIG. 2B, the macroblock texture measures for each frame are accumulated as each macroblock in the frame is encoded. Computation of the average texture measure is explained in more detail below in reference to FIG. 3.

The macroblock processing component (236) received frames of the input video sequence from the frame processing component (234) and encodes the frames to generate the compressed video stream. FIG. 2B shows the basic coding architecture of the macroblock processing component (236). The frames from the frame processing component (234) are provided as one input of a motion estimation component (220), as one input of a mode conversion switch (230), as one input to a combiner (228) (e.g., adder or subtractor or the like), and as one input of an intra prediction estimation component (232). The frame storage component (218) provides reference data to the motion estimation component (220) and to the motion compensation component (222). The reference data may include one or more previously encoded and decoded frames.

The motion estimation component (220) provides motion estimation information to the motion compensation component (222), the mode control component (226), and the entropy encode component (206). More specifically, the motion estimation component (220) processes each macroblock in a frame and performs searches based on the prediction modes defined in the standard to choose the best motion vector(s)/prediction mode for each macroblock based on encoding cost, i.e., interprediction cost, resulting from each prediction mode. The motion estimation component (220) provides the selected motion vector (MV) or vectors to the motion compensation component (222) and the entropy encode component (206), and the interprediction cost for the selected prediction mode to the mode control component (226).

The intra prediction estimation component (232) provides an intraprediction cost for each macroblock to the mode control component (226) and a texture measure for each macroblock to the quantization component (202). More specifically, the intra prediction estimation component (232) processes each macroblock in a frame and computes an intraprediction cost for the macroblock and a texture measure for the macroblock. The macroblock texture measure may be computed using any suitable texture measure computation technique, such as, for example, the techniques discussed in more detail below in reference to FIG. 3. The intra prediction estimation component (232) also accumulates and stores the macroblock texture measures for a frame in the memory (238) for use by the frame processing component (234).

The mode control component (226) controls the two mode conversion switches (224, 230) based on the intraprediction cost and the interprediction cost provided by the intra prediction estimation component (232) and the motion estimation component (220). When the interprediction cost is lower than the intraprediction cost, the mode control component (226) sets the mode conversion switch (230) to feed the output of the combiner (228) to the DCT component (200) and sets the mode conversion switch (224) to feed the output of the motion compensation component (222) to the combiner (216). When the intraprediction cost is lower, the mode control component (226) sets the mode conversion switch (230) to feed the intra predicted frames from the intra prediction estimation component (232) to the DCT component (200) and sets the mode conversion switch (224) to feed data from the frame storage (218) to the combiner (216).

The motion compensation component (222) provides motion compensated prediction information based on the motion vectors received from the motion estimation component (220) as one input to the combiner (228) and to the mode conversion switch (224). The motion compensated prediction information includes motion compensated interframe macroblocks, i.e., prediction macroblocks. The combiner (228) subtracts the selected prediction macroblock from the current macroblock of the current input frame to provide a residual macroblock to the mode conversion switch (230). The resulting residual macroblock is a set of pixel difference values that quantify differences between pixel values of the original macroblock and the prediction macroblock.

The mode conversion switch (203) then provides either the residual macroblock or the current macroblock to the DCT component (200) based on the current prediction mode. The DCT component (200) performs a block transform, e.g., discrete cosine transform (DCT), on the macroblock and outputs the transform result. The transform result is provided to a quantization component (202) which outputs quantized transform coefficients.

The quantization component (202) includes functionality to adapt the quantization step size computed for a frame by the frame processing component (234) for each macroblock in the frame based on the macroblock texture measure computed by the intra prediction estimation component (232) and the average texture measure computed by the frame processing component (234). More specifically, the functionality included in the quantization component (202) computes a quantization step size for a macroblock by multiplying the frame quantization step size by a multiplication factor chosen based on the ratio of the macroblock texture measure and the average texture measure. Selection of the multiplication factor is described in more detail below in reference to FIG. 3. The quantization component (202) uses the adapted quantization step size to quantize the transform coefficients.

The quantized transform coefficients are provided to the DC/AC (Discrete Coefficient/Alternative Coefficient) prediction component (204). AC is typically defined as a DCT coefficient for which the frequency in one or both dimensions is non-zero (higher frequency). DC is typically defined as a DCT coefficient for which the frequency is zero (low frequency) in both dimensions. The DC/AC prediction component (204) predicts the AC and DC for the current macroblock based on AC and DC values of adjacent macroblocks such as an adjacent left top macroblock, a top macroblock, and an adjacent left macroblock. More specifically, the DC/AC prediction component (204) calculates predictor coefficients from quantized coefficients of neighboring macroblocks and then outputs the differentiation of the quantized coefficients of the current macroblock and the predictor coefficients. The differentiation of the quantized coefficients is provided to the entropy encode component (206), which encodes them and provides a compressed video bit stream for transmission or storage. The entropy coding performed by the entropy encode component (206) may be any suitable entropy encoding techniques, such as, for example, context adaptive variable length coding (CAVLC), context adaptive binary arithmetic coding (CABAC), run length coding, etc.

Inside every encoder is an embedded decoder. As any compliant decoder is expected to reconstruct an image from a compressed bit stream, the embedded decoder provides the same utility to the video encoder. Knowledge of the reconstructed input allows the video encoder to transmit the appropriate residual energy to compose subsequent frames. To determine the reconstructed input, the quantized transform coefficients from the quantization component (202) are provided to an inverse quantize component (212) which outputs estimated transformed information, i.e., an estimated or reconstructed version of the transform result from the DCT component (200). The estimated transformed information is provided to the inverse DCT component (214), which outputs estimated residual information which represents a reconstructed version of the residual macroblock. The reconstructed residual macroblock is provided to a combiner (216). The combiner (216) adds the predicted macroblock from the motion compensation component (222) (if available) to the reconstructed residual macroblock to generate an unfiltered reconstructed macroblock, which becomes part of reconstructed frame information. The reconstructed frame information, i.e., reference frame, is stored in the frame storage component (218) which provides the reconstructed frame information as reference frames to the motion estimation component (220) and the motion compensation component (222).

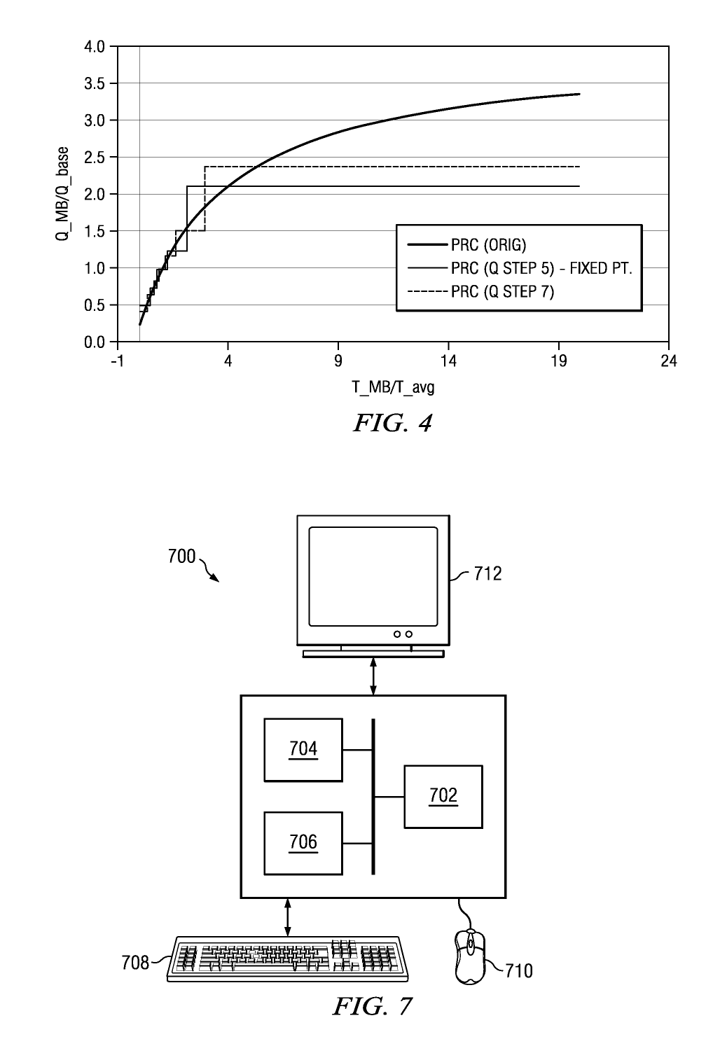

FIG. 3 shows a flow graph of a method for low complexity adaptive quantization during coding of a digital video sequence in accordance with one or more embodiments of the invention. In embodiments of the method, a texture measure is calculated for each macroblock in a current frame of the video sequence. The texture measure provides a quantitative measure of the texture content of the macroblock. The quantization step size to be used for the macroblock is then selected based on a discrete mapping from the texture measure to the quantization step size. An example of the mapping from texture measure to quantization step size is shown in FIG. 4. More specifically, the quantization step size for the macroblock, Q_{mb}, is derived as a function of (i) the quantization step size, Q_{base}, selected by rate control of the video encoder, (ii) the texture measure, and (iii) the average texture measure of the previous N frames.

Initially, an average texture measure, TM_{avg}, is computed for the previous N frames (300). In one or more embodiments of the invention, the average texture measure is computed as

$${TM}_{avg} = {\sum }_{i = 0}^{N - 1} {\sum }_{j = 0}^{M - 1} TM ( i , j ) / ( N * M )$$

where N is the number of frames to be included in the average, M is the number of macroblocks in a frame, and TM (i, j) is the texture measure of the j^{th} macroblock in the i^{th} previous frame. Computation of a texture measure for a macroblock is described below. The value of N may be empirically determined. In some embodiments of the invention, N=1.

Then, as each macroblock in the frame is encoded (302), a texture measure, TM, is computed for the macroblock (304), the quantization step size for the macroblock is computed (306-318), and quantization is performed for the macroblock using the computed quantization step size (320). The texture measure, TM, may be computed using any suitable texture measure computation technique. For example, in the frequency domain, a 2-D FFT/DCT may be performed on the macroblock and the energy in the higher frequency coefficients used as the texture measure. In the wavelet domain, a wavelet decomposition may be performed on the macroblock and the energy in the higher sub-bands used as the texture measure. In the spatial domain, the variance of the macroblocks may be computed and used as the texture measure.

In one or more embodiments of the invention, the texture measure, TM=ACT16(n), is computed as the sum of the horizontal activity, ACT16X, and vertical activity, aCT16Y, in the macroblock:

$$ACT 16 ( n ) = ACT 16 X ( n ) + ACT 16 Y ( n )$$

$$ACT 16 X ( n ) = {\sum }_{j = 0}^{3} {\sum }_{i = 0}^{3} {\sum }_{y = 0}^{3} {\sum }_{x = 0}^{2} \vert \begin{matrix}{curr}_{( n )} ( y + 4 j , x + 4 i ) - \\ {curr}_{( n )} ( y + 4 j , x + 4 i + 1 )\end{matrix} \vert$$

$$ACT 16 Y ( n ) = {\sum }_{j = 0}^{3} {\sum }_{i = 0}^{3} {\sum }_{x = 0}^{3} {\sum }_{y = 0}^{2} \vert \begin{matrix}{curr}_{( n )} ( y + 4 j , x + 4 i ) - \\ {curr}_{( n )} ( y + 4 j + 1 , x + 4 i )\end{matrix} \vert$$

where curr(n) is the luminance pixel values of the n^{th} macroblock, i and j are indices of 4×4 subblocks in the 16×16 macroblock, and x and y are indices of the pixels in a 4×4 block. ACT16X is computed as the sum of the gradient in the horizontal direction at a 4×4 block level. In the computation, every pixel in the 4×4 block is compared to the pixel immediately to the right of it and the absolute difference is accumulated for the 4×4 block. The accumulated value for all 16 4×4 blocks in the macroblock is the horizontal activity of the macroblock. ACT16Y is similarly computed as the sum of the gradient in the vertical direction. Note that for horizontal activity (ACT16X), the range of x is 0,1,2 and range of y is 0,1,2,3. Here x is the horizontal index and y is the vertical index. Similarly for ACT16Y, the range of x is 0,1,2,3 and range of y is 0,1,2.

After the texture measure is computed, the quantization step size, Q_{mb}, is set to the base quantization step size, Q_{base}, multiplied by a multiplication factor chosen based on the ratio of the texture measure, TM, and the average texture measure, TM_{avg} (306-318). More specifically, the quantization step size of the macroblock is set to the base quantization step size multiplied by a multiplication factor. The base quantization step size, Q_{base}, is the quantization step size selected by rate control technique of the video encoder. Any suitable rate control technique may be used. As is known in the art, rate control may modify the quantization step size after encoding several macroblocks. The modification may be done at frame boundaries, after encoding a row of macroblocks in a frame, or after coding N macroblocks where N is any value greater than 1. For example, in TM5, the base quantization step size for a frame is computed based on the quantization step size of the previous frame, bits consumed by the previous frame, and the target bit rate of the encoder.

The multiplication factor is chosen based on the ratio of the texture measure of the current macroblock, TM, and the average texture measure, TM_{avg}. More specifically, if the ratio lies between two empirically determined texture thresholds, thresᵢ₋₁ and thresᵢ, then the multiplication factor chosen is mulᵢ as shown below.

$$If ( {thres}_{i - 1} < \frac{TM}{{TM}_{avg}} \leq {thres}_{i} )$$

$${Q}_{mb} = {Q}_{base} * {mul}_{i}$$

The values of the texture thresholds, thresᵢ, are in increasing order of magnitude as are the values of the multiplication factors, mulᵢ. This is in accordance with the theory of texture masking, i.e., the higher the texture, the larger the quantization step size. In one or more embodiments of the invention, the values of the texture thresholds, thresᵢ, and the values of the multiplication factors, mulᵢ, are selected by approximating the continuous function of the mapping of the ratio of TM/TM_{avg} to the ratio of Q_{mb}/Q_{base} with a discrete approximation (e.g., FIG. 4, where the X-axis is the ratio TM/TM_{avg} (or thres) and Y-axis is the ratio of Q_{mb}/Q_{base} (or mul)). The discrete approximation fixes the number of quantization step sizes to be allowed per base quantization step size, i.e., the quantization step size computed by rate control, and finds the threshold values and multiplication factors that minimize the least squares error (LSE) between the continuous and discrete curves. In essence, the discrete approximation fixes the number of quantization step sizes (i.e., quantization scales) that may be used for a particular Q_{base} value.

The choice of the number of thresholds and multiplication factors, i.e., the number of allowable quantization step sizes, is implementation dependent. In one or more embodiments of the invention, the number of thresholds and multiplication factors is chosen based on a compromise between complexity of implementation and minimization of LSE between the curves. If the number is large, the complexity will increase but the LSE will decrease and vice versa. In one or more embodiments of the invention, the number of thresholds and multiplication factors selected is five. In some embodiments of the invention, the number of thresholds and multiplication factors selected is seven. Other techniques may also be used to choose the number of thresholds and multiplication factors such as, for example, other curve fitting techniques.

Using this method, the complexity of deriving the quantization step size for a macroblock is low. For example, Table 1 shows pseudo code for computing the quantization step size in one or more embodiments of the invention when the number of thresholds and multiplications is five, and Table 2 shows pseudo code for computing the quantization step size in one or more embodiments of the invention for when the number is seven. Note that the code uses comparisons and a fixed point multiplication whereas previous solutions make use of complex division or large look up tables to derive the quantization step size for a macroblock, which makes the method more attractive for implementation on real-time embedded systems. Further, the computation of TM_{avg} may be performed at the frame level and thus will not contribute to implementation complexity when encoding individual macroblocks.

TABLE 1

if (TM > 2.125 * TM_{avg}) Q_{mb} = 2.125*Q_{base}
else if (TM > 1.25 * TM_{avg}) Q_{mb} = 1.25*Q_{base}
else if (TM < 0.5* TM_{avg}) Q_{mb} = 0.5* Q_{base}
else if (TM < 0.75* TM_{avg}) Q_{mb} = 0.75* Q_{base}
else Q_{mb} = Q_{base}

TABLE 2

if (TM > 3 * TM_{avg}) Q_{mb} = 2.4*Q_{base}
else if (TM > 1.625 * TM_{avg}) Q_{mb} = 1.5*Q_{base}
else if (TM > 1.14* TM_{avg}) Q_{mb} = 1.2* Q_{base}
else if (TM < 0.34* TM_{avg}) Q_{mb} = 0.42* Q_{base}
else if (TM < 0.62* TM_{avg}) Q_{mb} = 0.66* Q_{base}
else if (TM < 0.875* TM_{avg}) Q_{mb} = 0.84* Q_{base}
else Q_{mb} = Q_{base}

Using the above method, relatively homogenous regions (e.g., sky) are assigned the same quantization step size. This provides in the same quality for similar adjacent macroblocks and also provides for a reduction of bit rate as many video encoders are very efficient in encoding the QP delta when adjacent macroblocks have the same quantization step size.

The differential mean opinion score (DMOS) improvement using embodiments of the method in encoding of test video sequences is shown in Table 3. In this table, PRC represents adaptive quantization with a continuous quantization step-size, where the quantization step size is computed as

$${Q}_{MB} = ( \frac{4 \times {T}_{MB} + {T}_{avg}}{{T}_{MB} + 4 \times {T}_{avg}} ) {Q}_{base}$$

and all possible quantization step sizes as specified by the coding standard are allowed. PRC-step5 represents adaptive quantization in accordance with an embodiment of the above with five multiplication factors/thresholds, i.e., five quantization step sizes, and PRC-step7 represents an embodiment of the above method with seven multiplication factors/thresholds i.e., seven quantization step sizes. For the test video sequences, the maximum and minimum DMOS scores are all better for PRC-step5 and PRC-step7 as compared to the continuous PRC quantization step derivation (lower values of DMOS indicate better video quality).

TABLE 3

| | | | | Gain of PRC- | Gain of PRC- |
|---|---|---|---|---|---|
| DMOS | PRC | PRC-step5 | PRC-step7 | step5 over PRC | step7 over PRC |
| average | 5.21 | 5.18 | 5.13 | 0.029 | 0.085 |
| max | 28 | 27.60 | 27.10 | 0.39 | 1.04 |
| min | 1.53 | 1.51 | 1.59 | −0.32 | −0.22 |

Embodiments of the encoders and methods described herein may be provided on any of several types of digital systems: digital signal processors (DSPs), general purpose programmable processors, application specific circuits, or systems on a chip (SoC) such as combinations of a DSP and a reduced instruction set (RISC) processor together with various specialized programmable accelerators. A stored program in an onboard or external (flash EEP) ROM or FRAM may be used to implement the video signal processing. Analog-to-digital converters and digital-to-analog converters provide coupling to the real world, modulators and demodulators (plus antennas for air interfaces) can provide coupling for transmission waveforms, and packetizers can provide formats for transmission over networks such as the Internet.

The techniques described in this disclosure may be implemented in hardware, software, firmware, or any combination thereof. If implemented in software, the software may be executed in one or more processors, such as a microprocessor, application specific integrated circuit (ASIC), field programmable gate array (FPGA), or digital signal processor (DSP). The software that executes the techniques may be initially stored in a computer-readable medium such as compact disc (CD), a diskette, a tape, a file, memory, or any other computer readable storage device and loaded and executed in the processor. In some cases, the software may also be sold in a computer program product, which includes the computer-readable medium and packaging materials for the computer-readable medium. In some cases, the software instructions may be distributed via removable computer readable media (e.g., floppy disk, optical disk, flash memory, USB key), via a transmission path from computer readable media on another digital system, etc.

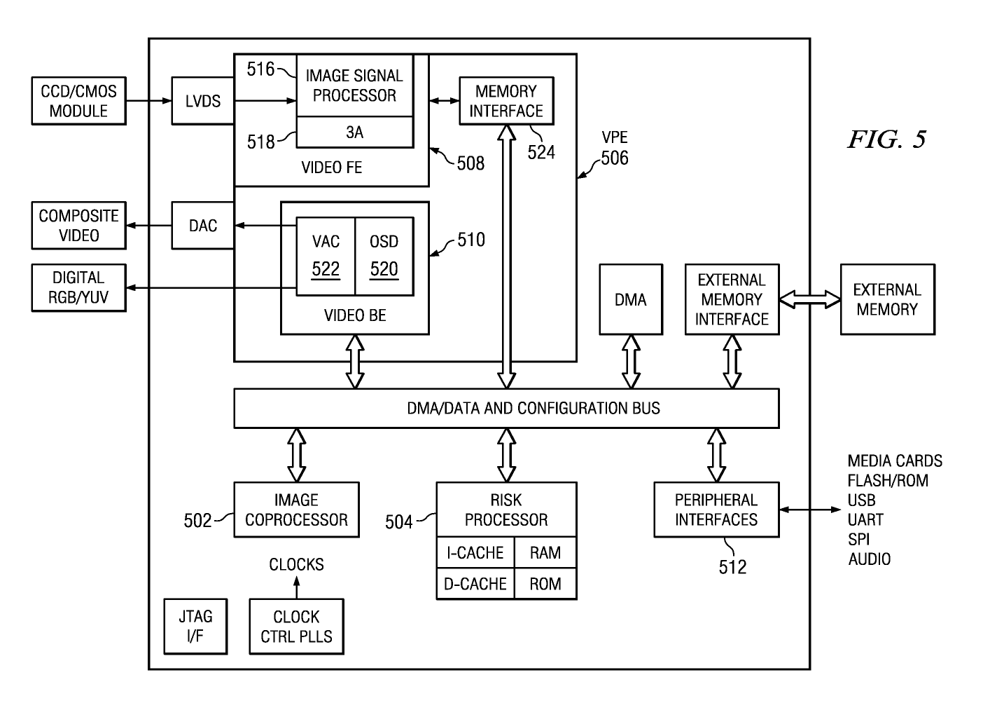

Embodiments of the methods and encoders for low complexity adaptive quantization as described herein may be implemented for virtually any type of digital system (e.g., a desk top computer, a laptop computer, a handheld device such as a mobile (i.e., cellular) phone, a personal digital assistant, a digital camera, etc.) with functionality to capture or otherwise generate digital video sequences. FIGS. 5-7 show block diagrams of illustrative digital systems.

FIG. 5 shows a digital system suitable for an embedded system (e.g., a digital camera) in accordance with one or more embodiments of the invention that includes, among other components, a DSP-based image coprocessor (ICP) (502), a RISC processor (504), and a video processing engine (VPE) (506) that may be configured to perform methods as described herein. The RISC processor (504) may be any suitably configured RISC processor. The VPE (506) includes a configurable video processing front-end (Video FE) (508) input interface used for video capture from imaging peripherals such as image sensors, video decoders, etc., a configurable video processing back-end (Video BE) (510) output interface used for display devices such as SDTV displays, digital LCD panels, HDTV video encoders, etc, and memory interface (524) shared by the Video FE (508) and the Video BE (510). The digital system also includes peripheral interfaces (512) for various peripherals that may include a multi-media card, an audio serial port, a Universal Serial Bus (USB) controller, a serial port interface, etc.

The Video FE (508) includes an image signal processor (ISP) (516), and a 3A statistic generator (3A) (518). The ISP (516) provides an interface to image sensors and digital video sources. More specifically, the ISP (516) may accept raw image/video data from a sensor (CMOS or CCD) and can accept YUV video data in numerous formats. The ISP (516) also includes a parameterized image processing module with functionality to generate image data in a color format (e.g., RGB) from raw CCD/CMOS data. The ISP (516) is customizable for each sensor type and supports video frame rates for preview displays of captured digital images and for video recording modes. The ISP (516) also includes, among other functionality, an image resizer, statistics collection functionality, and a boundary signal calculator. The 3A module (518) includes functionality to support control loops for auto focus, auto white balance, and auto exposure by collecting metrics on the raw image data from the ISP (516) or external memory.

The Video BE (510) includes an on-screen display engine (OSD) (520) and a video analog encoder (VAC) (522). The OSD engine (520) includes functionality to manage display data in various formats for several different types of hardware display windows and it also handles gathering and blending of video data and display/bitmap data into a single display window before providing the data to the VAC (522) in YCbCr format. The VAC (522) includes functionality to take the display frame from the OSD engine (520) and format it into the desired output format and output signals required to interface to display devices. The VAC (522) may interface to composite NTSC/PAL video devices, S-Video devices, digital LCD devices, high-definition video encoders, DVI/HDMI devices, etc.

The memory interface (524) functions as the primary source and sink to modules in the Video FE (508) and the Video BE (510) that are requesting and/or transferring data to/from external memory. The memory interface (524) includes read and write buffers and arbitration logic.

The ICP (502) includes functionality to perform the computational operations required for video encoding and other processing of captured images. The video encoding standards supported may include one or more of the JPEG standards, the MPEG standards, and the H.26x standards. In one or more embodiments of the invention, the ICP (502) is configured to perform computational operations of methods as described herein.

In operation, to capture an image or video sequence, video signals are received by the video FE (508) and converted to the input format needed to perform video encoding. The video data generated by the video FE (508) is stored in then stored in external memory. The video data is then encoded by a video encoder and stored in external memory. During the encoding, a method for adaptive quantization as described herein may be used. The encoded video data may then be read from the external memory, decoded, and post-processed by the video BE (510) to display the image/video sequence.

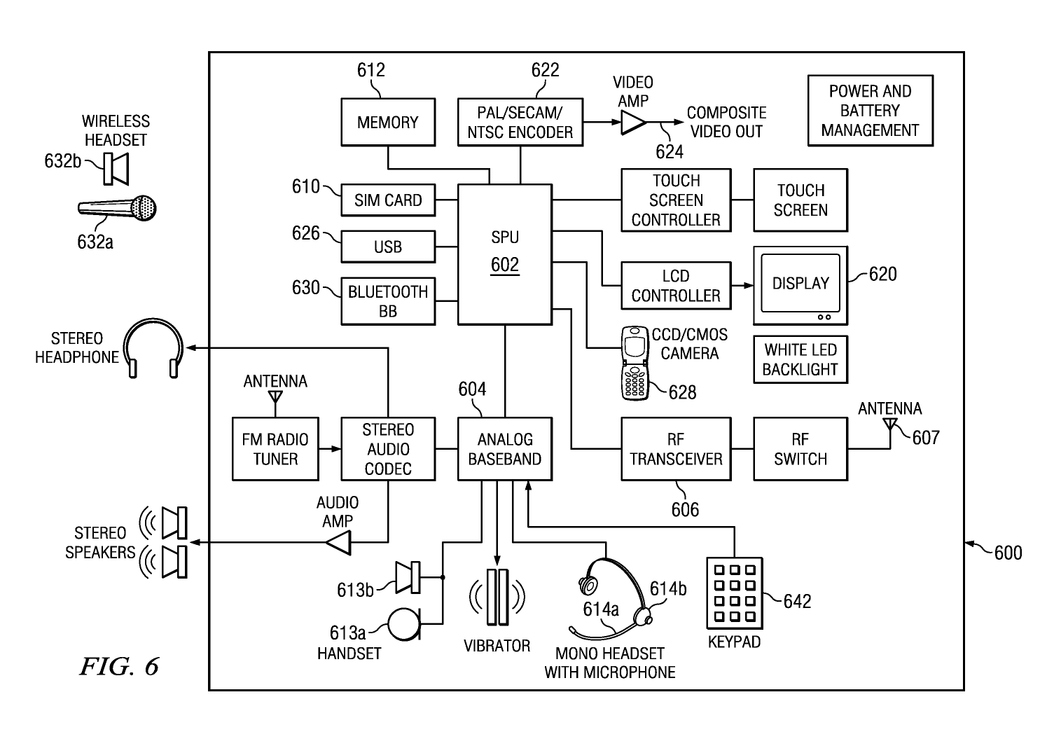

FIG. 6 is a block diagram of a digital system (e.g., a mobile cellular telephone) (600) that may be configured to perform the methods described herein. The signal processing unit (SPU) (602) includes a digital signal processing system (DSP) that includes embedded memory and security features. The analog baseband unit (604) receives a voice data stream from handset microphone (613a) and sends a voice data stream to the handset mono speaker (613b). The analog baseband unit (604) also receives a voice data stream from the microphone (614a) and sends a voice data stream to the mono headset (614b). The analog baseband unit (604) and the SPU (602) may be separate ICs. In many embodiments, the analog baseband unit (604) does not embed a programmable processor core, but performs processing based on configuration of audio paths, filters, gains, etc being setup by software running on the SPU (602).

The display (620) may also display pictures and video streams received from the network, from a local camera (628), or from other sources such as the USB (626) or the memory (612). The SPU (602) may also send a video stream to the display (620) that is received from various sources such as the cellular network via the RF transceiver (606) or the camera (626). The SPU (602) may also send a video stream to an external video display unit via the encoder (622) over a composite output terminal (624). The encoder unit (622) may provide encoding according to PAL/SECAM/NTSC video standards.

The SPU (602) includes functionality to perform the computational operations required for video encoding and decoding. The video encoding standards supported may include, for example, one or more of the JPEG standards, the MPEG standards, and the H.26x standards. In one or more embodiments of the invention, the SPU (602) is configured to perform computational operations of a method for adaptive quantization as described herein. Software instructions implementing the method may be stored in the memory (612) and executed by the SPU (602) as part of capturing and/or encoding of digital image data, e.g., pictures and video streams.

FIG. 7 shows a digital system (700) (e.g., a personal computer) that includes a processor (702), associated memory (704), a storage device (706), and numerous other elements and functionalities typical of digital systems (not shown). In one or more embodiments of the invention, a digital system may include multiple processors and/or one or more of the processors may be digital signal processors. The digital system (700) may also include input means, such as a keyboard (708) and a mouse (710) (or other cursor control device), and output means, such as a monitor (712) (or other display device). The digital system (700) may also include an image capture device (not shown) that includes circuitry (e.g., optics, a sensor, readout electronics) for capturing video sequences. The digital system (700) may include a video encoder with functionality to perform embodiments of a method for adaptive quantization as described herein. The digital system (700) may be connected to a network (714) (e.g., a local area network (LAN), a wide area network (WAN) such as the Internet, a cellular network, any other similar type of network and/or any combination thereof) via a network interface connection (not shown). Those skilled in the art will appreciate that the input and output means may take other forms.

Further, those skilled in the art will appreciate that one or more elements of the aforementioned digital system (700) may be located at a remote location and connected to the other elements over a network. Further, embodiments of the invention may be implemented on a distributed system having a plurality of nodes, where each portion of the system and software instructions may be located on a different node within the distributed system. In one embodiment of the invention, the node may be a digital system. Alternatively, the node may be a processor with associated physical memory. The node may alternatively be a processor with shared memory and/or resources.

Software instructions to perform embodiments of the invention may be stored on a computer readable medium such as a compact disc (CD), a diskette, a tape, a file, memory, or any other computer readable storage device. The software instructions may be distributed to the digital system (700) via removable computer readable media (e.g., floppy disk, optical disk, flash memory, USB key), via a transmission path from computer readable media on another digital system, etc.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims. It is therefore contemplated that the appended claims will cover any such modifications of the embodiments as fall within the true scope and spirit of the invention.

What is claimed is:

1. A method of encoding a block of pixels in a digital video sequence, the method comprising:
computing an average texture measure for a plurality of blocks of pixels encoded prior to the block of pixels;
computing a texture measure for the block of pixels;
computing a block quantization step size for the block of pixels as the product of a quantization step size selected for a sequence of blocks of pixels comprising the block of pixels and a multiplication factor selected from a set of multiplication factors based on a ratio of the texture measure and the average texture measure; and
quantizing the block of pixels using the block quantization step size.

2. The method of claim 1, wherein computing a block quantization step size comprises:
when the ratio is between two texture thresholds, thresᵢ₋₁ and thresᵢ, of a set of texture thresholds, selecting mulᵢ as the multiplication factor, where i is a number of multiplication factors in the plurality of multiplication factors and a number of texture thresholds in the set of texture thresholds.

3. The method of claim 2, wherein values of the mulᵢ and the thresᵢ are in increasing order of magnitude.

4. The method of claim 2, wherein values of the mulᵢ and the thresᵢ are selected by approximating a continuous function mapping ratios of texture measures to average texture measures to ratios of block quantization step sizes to quantization step sizes provided by rate control with a discrete approximation that fixes a number of quantization step sizes.

5. The method of claim 1, wherein the sequence of blocks of pixels is a first frame in the digital video sequence and the block of pixels is a macroblock in the first frame.

6. The method of claim 5, wherein the plurality of blocks of pixels are comprised in a second frame of the digital video sequence immediately preceding the first frame.

7. The method of claim 1, wherein computing the texture measure comprises computing the texture measure as a sum of horizontal and vertical activity in the block of pixels.

8. The method of claim 1, wherein computing an average texture measure comprises computing an average of texture measures computed for the plurality of blocks of pixels.

9. A video encoder for encoding a digital video sequence, the video encoder comprising:
a texture measure component configured to compute a texture measure for a block of pixels in the digital video sequence;
a rate control component configured to compute a base quantization step size;
an average texture measure component configured to compute an average texture measure of a plurality of blocks of pixels preceding the block of pixels in the digital video sequence; and
a quantization component configured to compute a quantization step size for the block of pixels as the product of the base quantization step size and a multiplication factor selected from a set of multiplication factors based on a ratio of the texture measure and the average texture measure.

10. The video encoder of claim 9, wherein the quantization component is configured to select a multiplication factor mulᵢ from the set of multiplication factors when the ratio is between two texture thresholds, thresᵢ₋₁ and thresᵢ, of a set of texture thresholds, where i is a number of multiplication factors in the plurality of multiplication factors and a number of texture thresholds in the set of texture thresholds.

11. The video encoder of claim 10, wherein values of the mulᵢ and the thresᵢ are in increasing order of magnitude.

12. The video encoder of claim 10, wherein values of the mulᵢ and the thresᵢ are selected by approximating a continuous function mapping ratios of texture measures to average texture measures to ratios of block quantization step sizes to quantization step sizes provided by rate control with a discrete approximation that fixes a number of quantization step sizes.

13. The video encoder of claim 9, wherein the block of pixels is a macroblock in a first frame of the digital video sequence and the plurality of blocks of pixels are comprised in one or more frames of the digital video sequence preceding the first frame.

14. The video encoder of claim 9, wherein the texture measure component is configured to compute the texture measure as a sum of horizontal and vertical activity in the block of pixels.

15. The video encoder of claim 9, wherein the average texture measure component is configured to compute the average texture measure as an average of texture measures computed for the plurality of blocks of pixels.

16. A digital system configured to encode a digital video sequence, the digital system comprising:
means for computing a texture measure for a block of pixels in the digital video sequence;
means for computing a base quantization step size;
means for computing an average texture measure of a plurality of blocks of pixels preceding the block of pixels in the digital video sequence; and
means for computing a quantization step size for the block of pixels as the product of the base quantization step size and a multiplication factor selected from a set of multiplication factors based on a ratio of the texture measure and the average texture measure.

17. The digital system of claim 16, wherein the means for computing a quantization step size selects a multiplication factor mulᵢ from the set of multiplication factors when the ratio is between two texture thresholds, thresᵢ₋₁ and thresᵢ, of a set of texture thresholds, where i is a number of multiplication factors in the plurality of multiplication factors and a number of texture thresholds in the set of texture thresholds.

18. The digital system of claim 17, wherein values of the mulᵢ and the thresᵢ are in increasing order of magnitude.

19. The digital system of claim 17, wherein values of the mulᵢ and the thresᵢ are selected by approximating a continuous function mapping ratios of texture measures to average texture measures to ratios of block quantization step sizes to quantization step sizes provided by rate control with a discrete approximation that fixes a number of quantization step sizes.

20. The digital system of claim 16, wherein the means for computing a texture measure computes the texture measure as a sum of horizontal and vertical activity in the block of pixels and the means for computing the average texture measure computes the average texture measure as an average of texture measures computed for the plurality of blocks of pixels.
